(19) United States
(12) Patent Application Publication
(10) Pub. No.: US 2013/0177104 A1
(43) Pub. Date: Jul. 11, 2013

(54) ORTHOGONAL MULTI-RATE MODULATION DEVICE AND METHOD

(71) Applicant: National Taiwan University, Taipei (TW)

(72) Inventors: Char-Dir CHUNG, Taipei (TW); Wei-Chang CHEN, Taipei (TW)

(73) Assignee: National Taiwan University, Taipei (TW)

(21) Appl. No.: 13/722,599

(22) Filed: Dec. 20, 2012

(30) Foreign Application Priority Data
Jan. 6, 2012 (TW) 101100737

(51) Int. Cl. H04L 27/36

(52) U.S. Cl. CPC H04L 27/367
USPC 375/296

(57) ABSTRACT

An orthogonal multi-rate modulation method for modulating a symbol vector made up of a plurality of data symbols is disclosed. The orthogonal multi-rate modulation method includes the following steps: firstly, a precoding matrix, in which the column vectors are mutually orthogonal, is provided. Then, a product of the symbol vector and the precoding matrix is made to generate a precoded vector. Finally, the precoded vector is filtered by a Nyquist Analog Filter, so as to output a complex baseband waveform.

### CROSS-REFERENCE TO RELATED APPLICATIONS

This application claims the benefit of Taiwan Patent Application No. 101100737, filed on Jan. 6, 2012 in the Taiwan Intellectual Property Office, the disclosure of which is incorporated herein in its entirety by reference.

### BACKGROUND OF THE INVENTION

1. Field of the Invention

The present invention generally relates to a multi-rate modulation method in particular to an orthogonal multi-rate modulation device and method.

2. Description of Related Art

At the present day, various communication services, such as speech and packet data, are provided by current wireless communication systems to meet the increase of mobile phone penetration rate and its rapidly-developed market. For the time being, the most commonly used modulation scheme is the square-root-raised-cosine-pulsed modulation, which needs excess bandwidth; therefore, under the bandlimited communication system, the loss of bandwidth efficiency will be incurred.

The bandwidth efficiency can be raised by the multi-rate modulation, which uses multi-rate filters. Compared with the square-root-raised-cosine-pulsed modulation, the multi-rate modulation does not need excess bandwidth but have higher bits error rate.

Accordingly, it is one of the primary objectives of the present invention to provide a novel modulation device and method for the purpose of increasing the bandwidth efficiency without the sacrifice of the bits error rate.

### SUMMARY OF THE INVENTION

One of the primary objectives of the present invention is to provide a modulation device and method based on multi-rate modulation and improving multi-rate filter, which is capable of reducing bits error rate even if without excess bandwidth.

The present invention discloses an orthogonal multi-rate modulation method for modulating a data symbol vector composed of a plurality of data symbols. The orthogonal multi-rate modulation method comprises the following steps. First, a precoding matrix is provided, wherein the column vectors of the precoding matrix are orthogonal to one another. Next, the data symbol vector is multiplied by the precoding matrix to generate the precoded vector. Finally, the precoded vector is filtered by an analog filter to output a complex baseband waveform.

The present invention further discloses an orthogonal multi-rate modulation device for modulating a data symbol vector composed of a plurality of data symbols. The orthogonal multi-rate modulation device comprises a plurality of delay units, samplers, interpolators and FIR digital filters. The delay units are configured to delay data symbols to make the data symbols orderly correspond to a plurality of parallel branches. The samplers are coupled to the delay units and configured to sample the data symbols at the parallel branches. The interpolators are coupled to the samplers and configured to interpolate a string of zeros between the sampled data symbols. The FIR digital filters are coupled to the interpolators and configured to multiply the precoding matrix by the data symbol vectors.

### BRIEF DESCRIPTION OF THE DRAWINGS

The detailed structure, operating principle and effects of the present invention will now be described in more detail hereinafter with reference to the accompanying drawings that show various embodiments of the invention as follows.

FIG. 1 is a schematic view of the basic structure of a preferred embodiment of a wireless communication system in accordance with the present invention.

FIG. 2 is a schematic view of the structure of a preferred embodiment of a transmitter end in accordance with the present invention.

FIG. 3 is a schematic view of a preferred embodiment of a precoding matrix in accordance with the present invention.

FIG. 4 is a flow chart of a preferred embodiment of an orthogonal multi-rate modulation method in accordance with the present invention.

### DETAILED DESCRIPTION OF THE PREFERRED EMBODIMENTS

The technical content of the present invention will become apparent by the detailed description of the following embodiments and the illustration of related drawings as follows.

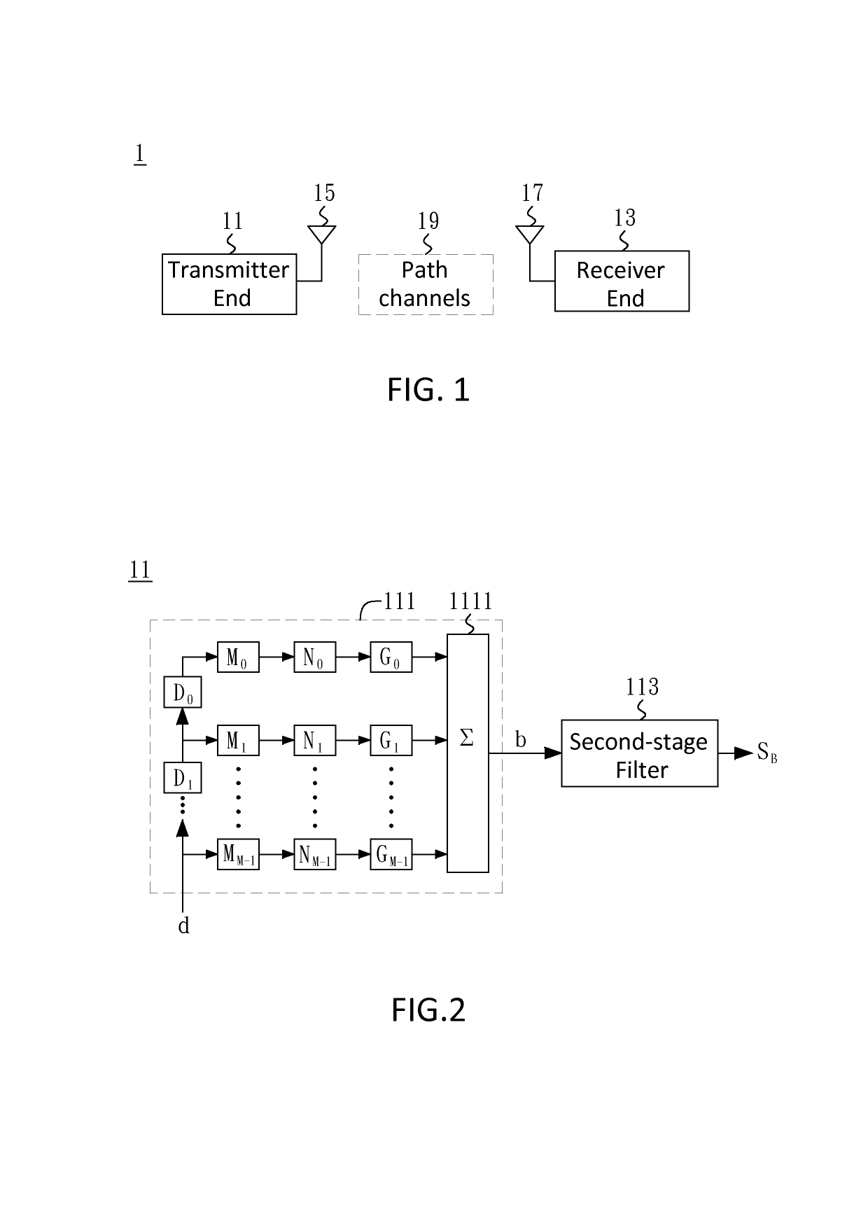

With reference to FIG. 1 for a schematic view of the basic structure of a preferred embodiment of a wireless communication system in accordance with the present invention, the wireless communication system 1 comprises at least a transmitter end 11 and a receiver end 13. An antenna 15 is disposed at the transmitter end 11 and an antenna 17 is disposed at the receiver end 13. Signals are processed by the transmitter end 11 (such as modulation) and then the processed signals may be transmitted to the receiver end 13 via the antenna 15. The receiver end 13 may receive the processed signals from the transmitter end 11 via the antenna 17, which will be further processed by some signal processing techniques (such as decode, demodulation and the like) to obtain useful information. Signals are transmitted to the receiver end 13 via the path channels 19.

Under the orthogonal multi-rate scheme, data flow will be processed by taking a block as a unit. That is to say, the data flow will be divided into multiple data symbol vectors to perform modulation. With reference to FIG. 2 for a schematic view of the structure of a preferred embodiment of a transmitter end in accordance with the present invention, the transmitter 11 comprises a first-stage filter 111 and a second-stage filter 113, which respectively perform filtering on data symbol vectors at different stages. The first-stage filter 111 is composed of M parallel branches, and each of the parallel branches is composed of a string of delay units D₀-D_{M-2}, samplers M₀-M_{M-1}, interpolators N₀-N_{M-1} and finite impulse response (FIR) digital filters G₀-G_{M-1}.

Each of the data symbol vectors d is constituted of multiple data symbols and will be input into the first-stage filter 111 to perform the first-stage filtering process. More specifically, the data symbol vector d is constituted of M symbols, which may be expressed in vector form as d=[d₀, d₁, . . . , d_{M-1}]^{t} where the superscript t denoting the transpose. After the data symbol vector d is received by the delay units D₀-D_{M-2}, the symbols d₀-d_{M-1} will be delayed by the delay units D₀-D_{M-2} so as to make the symbols d₀-d_{M-1} respectively correspond to M parallel branches. The samplers M₀-M_{M-1} are coupled to the delay units D₀-D_{M-2}, which downsample the symbols d₀-d_{M-1} at the parallel branches by M. The interpolators N₀-N_{M-1} are coupled to the samples M₀-M_{M-1}, which upsample the sampled symbols by N. That is to say, N−1 zeros are interpolated between the sampled symbols to separate the downsampled symbols from each other.

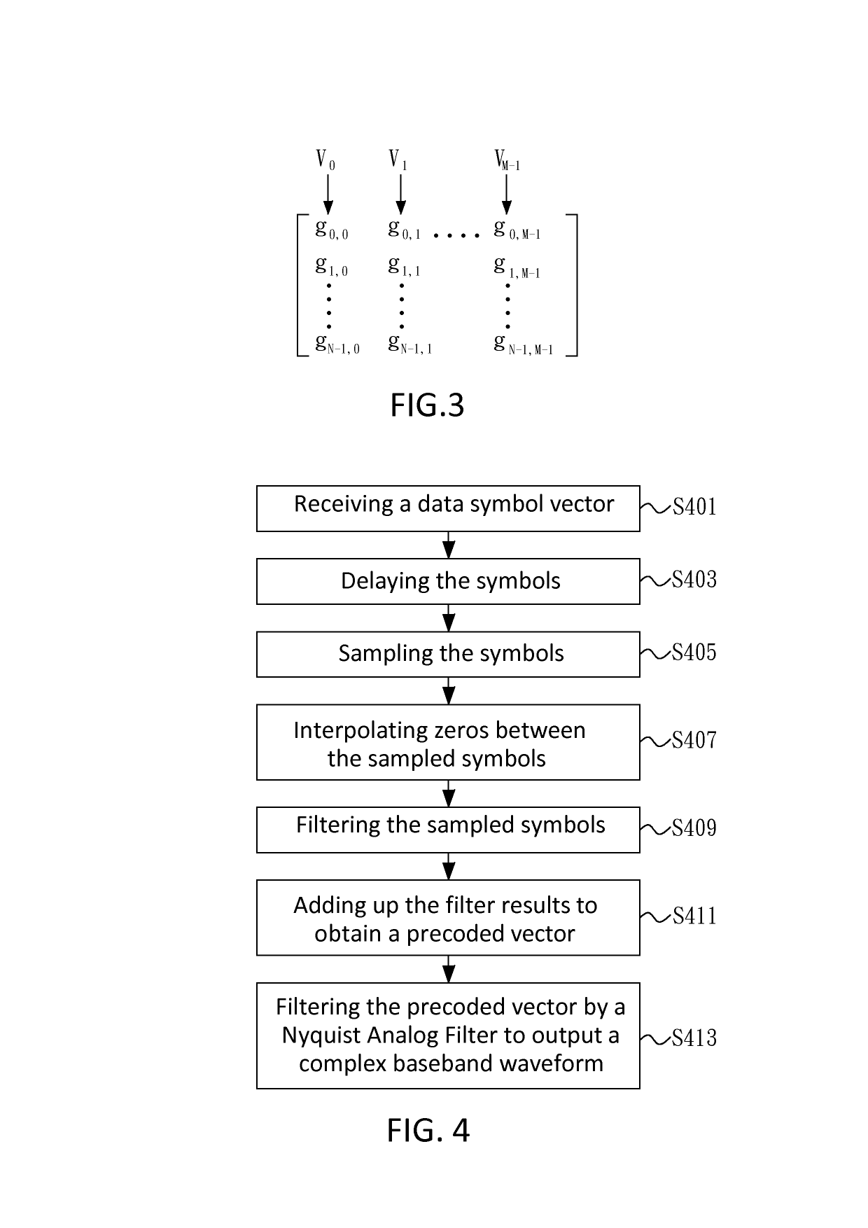

The FIR digital filters G₀-G_{M-1} are coupled to the interpolators N₀-N_{M-1}, wherein the coefficient of the filter Gₖ, one of the filters G₀-G_{M-1}, is corresponding to the kₜₕ column vector of a precoding matrix having column vectors orthogonal to one another. As shown in FIG. 3, the column vectors V₀-V_{M-1} of the precoding matrix are orthogonal to one another, which meet the formula (1) as shown below.

$${\sum }_{n = 0}^{N - 1} {g}_{n , m} {g}_{n , k} = δ ( m , k ) for m , k = 0 , 1 , … , M - 1 \qquad ( 1 )$$

Besides, in order to realize an orthogonal multi-rate modulator, the column vectors V₀-V_{M-1} of the precoding matrix should further meet the formula (2) as shown below.

$${\sum }_{n = 0}^{N - 1} {{g}_{n , m} ( - 1 )}^{n} = 0 for m = 0 , 1 , … , M - 1 \qquad ( 2 )$$

The product of data symbol vector d and the precoding matrix may be realized by the FIR digital filters G₀-G_{M-1} in order to generate a precoded vector. More specifically, after the sampled symbols are filtered by the FIR digital filters G₀-G_{M-1}, the outputs of the FIR digital filters G₀-G_{M-1} will be added up by the first-stage filter 111 via the adder 1111 coupled to the FIR digital filters G₀-G_{M-1} so as to obtain a precoded vector b, such that b=G*d is realized.

After the first-stage filtering process is finished, the second-stage filtering process will be performed by the second-stage filter 113. The second-stage filter 113 is coupled to the adder 1111, which uses a Nyquist Analog Filter to filter the precoded vector b to output a complex baseband waveform S (the modulated signal to be output).

The formula (1) shows that the precoding matrix has column vectors orthogonal to one another, which also meets the formula (3) as shown below.

∫_{-∞}^{∞}qₘ(t)qₖ(t−lt)dt=δ(m,k)δ(l,0) for m,k=0,1, . . . ,M−1 and l∈Z (3)

In the formula (3), qₖ(t−lT) denotes the component waveform of the complex baseband waveform S_{B} which modulates the kₜₕ data symbol dₖ of the lth data symbol vector, and T denotes the time for processing a data symbol vector. According to the formula (3), all component waveforms of the complex baseband waveform S are orthogonal to one another. Hence, mutual interference between data symbols at different branches will not take place and mutual interference between different data symbol vectors will also not take place, such that bit error rates can be reduced to be equivalent to that of the square-root-raised-cosine-pulsed modulation even if without excess bandwidth. In a preferred embodiment, the first-stage filter may be an Orthogonal Multi-rate Digital Filter, and the second-stage filter may be Nyquist Analog Filter or the like. The embodiments disclosed herein are just for example rather than limitation.

With reference to FIG. 4 for a flow chart of a preferred embodiment of an orthogonal multi-rate modulation method in accordance with the present invention, the method may comprise the following steps.

First, a data symbol vector d is received by the first-stage filter 111 of the transmitter end 11 (step S401), and then delay units D₀-D_{M-2} orderly delay the data symbol vector d to make each of the symbols d₀-d_{M-1} correspond to M parallel branches (step S403). Next, the symbols d₀-d_{M-1} are downsampled by the samplers M₀-M_{M-1} to sample the symbols d₀-d_{M-1} at the parallel branches (step S405), and then upsampled by the interpolators N₀-N_{M-1} to interpolate N−1 zeros between the sampled symbols (step S407).

As described above, the FIR digital filters G₀-G_{M-1} in accordance with the present invention have coefficients corresponding to the column vectors of a precoding matrix. The column vectors are orthogonal to one another and meet the formula (2). Accordingly, after the FIR digital filters G₀-G_{M-1} receives the sampled and interpolated symbols from the interpolators N₀-N_{M-1}, the sampled and interpolated symbols will be filtered by the FIR digital filters G₀-G_{M-1} (step S409) and then the adder 1111 will add up the filter results of the FIR digital filters G₀-G_{M-1} to obtain the precoded vector b (step S411), which means the first-stage filter is used to realize the product of the data symbol vector d and the precoding matrix in order to generate the precoded vector b. Finally, the precoded vector b is filtered by the second-stage filter 113 via the Nyquist Analog Filter to output a complex baseband waveform S_{B} (the modulated signal to be output) (step S413).

As the aforementioned description, conventional modulation methods either need excess bandwidth or have high bits error rate. On the contrary, the present invention is based on multi-rate modulation and makes the column vectors of the precoding matrix orthogonal to one another, such that all component waveforms are also orthogonal to one another. In this way, the present invention is capable of reducing bits error rate even if without excess bandwidth.

While the means of specific embodiments in the present invention has been described by reference to the drawings, numerous modifications and variations could be made thereto by those skilled in the art without departing from the scope and spirit of the invention as limited only by the appended claims.

What is claimed is:

1. An orthogonal multi-rate modulation method for modulating a data symbol vector, wherein the data symbol vector is composed of a plurality of data symbols, the orthogonal multi-rate modulation method comprises the following steps of
providing a precoding matrix, and column vectors of the precoding matrix are orthogonal to one another;
performing a first-stage filtering process, wherein the first-stage process comprises the step of:
multiplying the data symbol vector by the precoding matrix to generate a precoded vector; and
performing a second-stage filtering process, wherein the second-stage comprises the step of:
filtering the precoded vector by an analog filter to output a complex baseband waveform.

2. The orthogonal multi-rate modulation method of claim 1, wherein the first-stage filtering process further comprises the following steps of:
sampling the data symbols at a plurality of parallel branches corresponding to the data symbols; and
interpolating a string of zeros between sampled data symbols.

3. The orthogonal multi-rate modulation method of claim 2, wherein the first-stage filtering process further comprises the step of:
delaying the data symbols to make the data symbols orderly correspond to the parallel branches.

4. The orthogonal multi-rate modulation method of claim 3, wherein the first-stage filtering process is performed by a finite impulse response (FIR) digital filter or any orthogonal multi-rate filter, and the product step further comprises the following steps of:
processing the data symbols at the parallel branches by the FIR digital filters corresponding to precoding matrix column vector coefficients of the parallel branches in order to generate a plurality of filter vectors; and
adding up the filter vectors to generate the precoded vector.

5. The orthogonal multi-rate modulation method of claim 3, wherein the analog filter in the second-stage filtering process is a Nyquist Analog Filter.

6. An orthogonal multi-rate modulation device for modulating a data symbol vector, wherein the data symbol vector is composed of a plurality of data symbols, and the orthogonal multi-rate modulation device comprising:
a plurality of delay units configured to delay the data symbols to make the data symbols orderly correspond to a plurality of parallel branches;
a plurality of samplers coupled to the delay units and configured to sample the data symbols at the parallel branches;
a plurality of interpolators coupled to the samplers and configured to interpolate a string of zeros between the data symbols; and
a plurality of FIR digital filters coupled to the interpolators and having a coefficient corresponding to a precoding matrix having column vectors orthogonal to one another in order to realize a product of the precoding matrix and the data symbols.

7. The orthogonal multi-rate modulation device of claim 6, wherein the delay units, the samplers, the interpolators and the FIR digital filters are built in a first-stage filter, and the first-stage filter further comprises:
an adder coupled to the FIR digital filters and configured to add up filter results generated by the FIR digital filters so as to generate a precoded vector.

8. The orthogonal multi-rate modulation device of claim 7, further comprises:
a second-stage filter coupled to the adder and configured to filter the precoded vector by a Nyquist Analog Filter in order to output a complex baseband waveform.
